(19) United States
(12) Patent Application Publication
(10) Pub. No.: US 2026/0093268 A1
(43) Pub. Date: Apr. 2, 2026

(54) VEHICLE CONTROL DEVICE, REMOTE CONTROL SYSTEM

(71) Applicants: DENSO CORPORATION, Kariya-city (JP); J-QuAD DYNAMICS Inc., Tokyo (JP)

(72) Inventors: Daichi YAGI, Kariya-city (JP); Shota IBARA, Kariya-city (JP); Aika USUI, Kariya-city (JP); Yosuke HATTORI, Tokyo (JP); Ryu KAMBARA, Tokyo (JP); Hirotaka SAKAI, Tokyo (JP)

(21) Appl. No.: 19/339,971

(22) Filed: Sep. 25, 2025

(30) Foreign Application Priority Data
Sep. 30, 2024 (JP) 2024-169909

(51) Int. Cl. G05D 1/65; G05D 1/226; G05D 1/243; G05D 1/633

(52) U.S. Cl. CPC G05D 1/65; G05D 1/226; G05D 1/243; G05D 1/633

(57) ABSTRACT

A vehicle control device used in a vehicle configured to be remotely controllable is configured to communicate with one or more other devices mounted on the vehicle and to execute processing relating to travel control of the vehicle based on data received. The one or more other devices include a wireless communication device configured to execute wireless communication with a remote control device, which is an external device used to remotely control the vehicle. The vehicle control device is configured to acquire a communication state between the remote control device and the wireless communication device based on data received from the wireless communication device, and dynamically adjust an upper speed limit, which is an upper limit of travel speed in remote control of the vehicle, according to the communication state.

### CROSS REFERENCE TO RELATED APPLICATION

The present application is based on Japanese Patent Application No. 2024-169909 filed on Sep. 30, 2024. The entire disclosures of all of the above application are incorporated herein by reference.

### TECHNICAL FIELD

The present disclosure relates to a technology for remotely controlling the travel of a vehicle.

### BACKGROUND

A related art discloses an onboard device that controls the travel of a vehicle in accordance with an instruction signal transmitted from a remote control device. The remote control device predicts the traffic situation around the vehicle based on information received from the vehicle. Thereafter, when the latest traffic situation actually received from the onboard device does not match the predicted traffic situation, the remote control device instructs stopping or deceleration (for example, instead of a planned right turn at an intersection).

### SUMMARY

According to an aspect of the present disclosure, a vehicle control device used in a vehicle configured to be remotely controllable includes: a communication unit configured to communicate with one or more other devices mounted on the vehicle; and a processing unit configured to execute processing relating to travel control of the vehicle based on data. The one or more other devices may include a wireless communication device configured to execute wireless communication with a remote control device, which is an external device used to remotely control the vehicle. The vehicle control device may acquire a communication state between the remote control device and the wireless communication device based on data received from the wireless communication device, and dynamically adjust an upper speed limit, which is an upper limit of travel speed in remote control of the vehicle, according to the communication state.

### BRIEF DESCRIPTION OF DRAWINGS

Objects, features and advantages of the present disclosure will become more apparent from the following detailed description made with reference to the accompanying drawings. In the drawings:

FIG. 1 is a diagram schematically illustrating a vehicle management system;

FIG. 2 is a block diagram showing the configuration of an onboard system;

FIG. 3 is a block diagram showing an example of an environmental sensor;

FIG. 4 is a functional block diagram of a vehicle control device;

FIG. 5 is a block diagram showing the configuration of a remote monitoring system;

FIG. 6 is a flowchart illustrating an example of the operation of the onboard control device;

FIG. 7 is a flowchart of AEB determination processing;

FIG. 8 is a flowchart illustrating an example of the operation of the vehicle management system;

FIG. 9 is a flowchart of control in which data items transmitted from the vehicle to the remote monitoring system are changed according to the communication state;

FIG. 10 is a flowchart in which alert control is executed according to the communication state; and

FIG. 11 is a flowchart of route selection processing in the remote control device.

### DETAILED DESCRIPTION

In systems for remotely controlling vehicles, communication delay between the vehicle and the remote control device may become an issue. The related art merely discloses a configuration in which deceleration or stopping is instructed when there is a discrepancy between the predicted traffic situation and the actual traffic situation. In technologies for remotely controlling vehicles, further measures may be required to address deterioration in the communication state between the vehicle and the remote control device.

The present disclosure provides a technology capable of improving the safety of a remotely controlled vehicle or another road user present in the vicinity thereof.

According to one aspect of the present disclosure, a vehicle control device used in a vehicle configured to be remotely controllable comprises: a communication unit configured to communicate with one or more other devices mounted on the vehicle; and a processing unit configured to execute processing relating to travel control of the vehicle based on data received by the communication unit. The one or more other devices include a wireless communication device configured to execute wireless communication with a remote control device, which is an external device used to remotely control the vehicle. The processing unit is configured to: acquire a communication state between the remote control device and the wireless communication device based on data received from the wireless communication device by the communication unit; and dynamically adjust an upper speed limit, which is an upper limit of travel speed in remote control of the vehicle, according to the communication state.

According to one aspect of the present disclosure, a remote control system comprises: a vehicle control device used in a vehicle configured to be remotely controllable; and an external system disposed outside the vehicle for remotely controlling the vehicle. The vehicle control device includes: a communication unit configured to communicate with a wireless communication device that execute wireless communication with the external system; and a processing unit configured to execute processing relating to travel control of the vehicle based on data received by the communication unit. The processing unit is configured to: acquire a communication state between the external system and the wireless communication device based on data received from the wireless communication device by the communication unit; and dynamically adjust an upper speed limit, which is an upper limit of travel speed in a remote control of the vehicle, according to the communication state. The external system includes: a communication device configured to communicate with the vehicle control device; and a remote control device configured to execute processing for remotely controlling the vehicle based on data received by the communication device. The remote control device is configured to: acquire the communication state in association with position information of the vehicle with the communication device; store data of the communication state for each location in a memory; and determine a travel route of the vehicle based on the data of the communication state for each location stored in the memory.

According to the above technology, the upper speed limit during remote control travel is determined according to the communication state between the remote control device and the wireless communication device mounted on the vehicle. In other words, the travel speed is restricted according to the communication state. By restricting the travel speed, it is possible to reduce the risk of the vehicle traveling at excessively high speed when the communication state deteriorates. Therefore, the safety of the remotely controlled vehicle or another road user present in the vicinity thereof can be improved.

Hereinafter, embodiments of the present disclosure will be described with reference to the drawings. The present disclosure is not limited to the embodiments described below. The configurations disclosed below may be variously modified and implemented without departing from the gist of the disclosure. Various modifications may be appropriately combined and implemented as long as no technical contradiction arises. The present disclosure also includes configurations not explicitly described, which are combinations of multiple modifications. In the following description, the same reference numerals may be assigned to members having the same function, and detailed descriptions thereof may be omitted. In addition, the same or similar names may be given to members having the same function, and detailed descriptions thereof may be omitted. When only a part of a configuration is mentioned, the descriptions in other sections may be applied to the other parts.

### (Vehicle Management System)

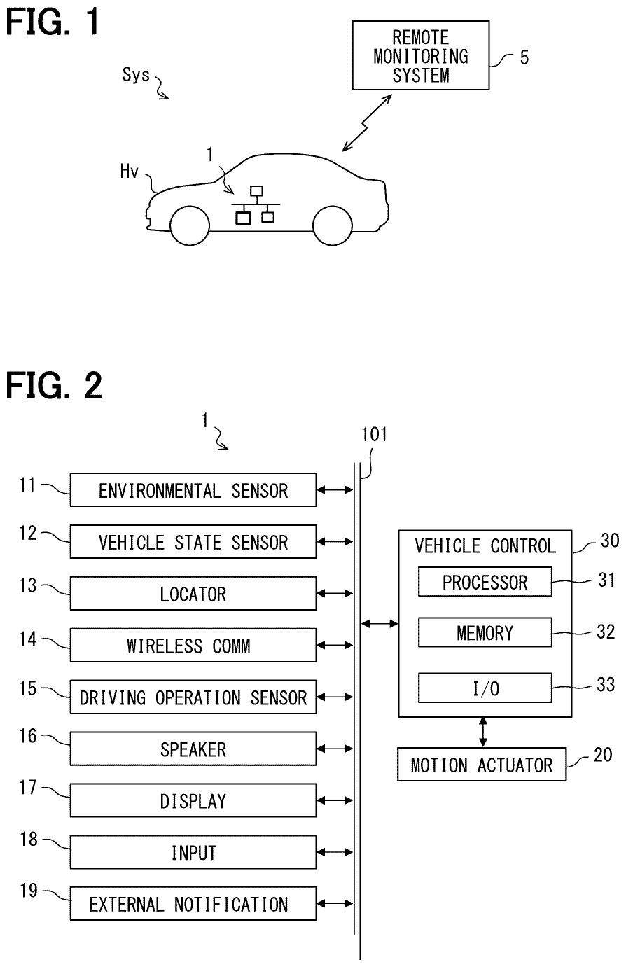

FIG. 1 is a diagram showing an example of the schematic configuration of a vehicle management system Sys according to the present disclosure. As shown in FIG. 1, the vehicle management system Sys of the present disclosure includes an onboard system 1 and a remote monitoring system 5. The vehicle management system Sys corresponds to a remote control system, and the remote monitoring system 5 corresponds to an external system.

The onboard system 1 is mounted on a host vehicle Hv. The remote monitoring system 5 is a system that recognizes the travel environment of the host vehicle Hv by wireless communication with the onboard system 1, and remotely operates the host vehicle Hv as necessary. The remote monitoring system 5 and the onboard system 1 are configured to be capable of mutual data communication via a wide-area communication network. The wide-area communication network may include a wireless section provided by a wireless base station, a wireless LAN router (in other words, an access point), or a communication satellite. The host vehicle Hv is configured to be remotely controllable by the remote monitoring system 5, as will be described later. For example, the host vehicle Hv may be configured to enable remote proxy driving.

The host vehicle Hv is a vehicle equipped with the onboard system 1. The host vehicle Hv may be, for example, a privately owned vehicle (so-called owner car). As an example, the host vehicle Hv of this embodiment has a plurality of driving operation members such as an accelerator pedal, a brake pedal, a steering wheel, and a shift lever. The driving operation members may also include operation members for actuating secondary actuators, such as a direction indicator switch (for example, a lever), a light switch, a wiper switch, and a hazard lamp switch. The secondary actuators refer to actuators that do not directly affect the movement of the host vehicle Hv but enable safe and legal driving. In contrast, actuators that directly affect the movement of the host vehicle Hv, such as the motion actuator 20 described later, may be referred to as primary actuators in the present disclosure. Note that the host vehicle Hv may also be configured to accept acceleration and deceleration operations by operation members other than pedals, such as buttons or levers.

The driver's seat in the following description refers to a seat in the host vehicle Hv suitable for operating the above driving operation members. The term “driver” in the following refers to a person seated in the driver's seat. The term “operator” refers to a person authorized to control the host vehicle Hv by remote operation from outside the host vehicle Hv. The operator may also be a person who operates the host vehicle Hv. Therefore, in a broad sense, the operator may also be regarded as one form of driver. In the following, the term “operator” may be replaced with “external operator,” and the term “driver” may be replaced with “in-vehicle operator.” In addition, the term “operator” may also be replaced with “external driver” or “remote driver.”

The host vehicle Hv may also be a service car such as a bus or taxi. The host vehicle Hv may be a shuttle bus, school bus, or truck. The host vehicle Hv may also be a service car in which no driver is present in the vehicle, such as an unmanned operation bus, autonomous operation bus, or robot bus. In other embodiments, the host vehicle Hv may be a vehicle without a driver's seat. Although only one host vehicle Hv is shown in FIG. 1, there may be a plurality of vehicles that can be remotely controlled by the remote monitoring system 5.

In the following description, the host vehicle Hv is exemplified as an electric vehicle. However, the type of the host vehicle Hv is not limited to an electric vehicle. The host vehicle Hv may be an engine vehicle or a hybrid vehicle. Electric vehicles include fuel cell vehicles (FCV: Fuel Cell Vehicle). Engine vehicles may include diesel vehicles.

The host vehicle Hv may be configured such that, in addition to the pressing operation of the power switch by the driver or administrator, the vehicle power supply is switched from off to on based on receiving a specific activation command from the remote monitoring system 5. The power switch is a switch arranged in the vehicle interior (for example, on the instrument panel) for switching the vehicle power supply on and off.

### (Onboard System)

As shown in FIG. 2, the onboard system 1 includes an environmental sensor 11, a vehicle state sensor 12, a locator 13, a wireless communication device 14, a driving operation sensor 15, a speaker 16, a display device 17, an input device 18, and an external notification device 19. The onboard system 1 also includes a motion actuator 20 and a vehicle control device 30. In addition to the configuration illustrated, the onboard system 1 may include various devices such as an audio device, air conditioning device, wiper system, and headlight system. The term “device” may include systems, subsystems, modules, sensors, and the like.

The vehicle control device 30 is connected via an in-vehicle network 101 to the environmental sensor 11, the vehicle state sensor 12, the locator 13, the wireless communication device 14, the driving operation sensor 15, the speaker 16, the display device 17, and the external notification device 19, enabling mutual communication. The vehicle control device 30 is also connected to the motion actuator 20 by a dedicated cable, without passing through the in-vehicle network 101.

The in-vehicle network 101 is a communication network constructed within the vehicle. The in-vehicle network 101 may be a communication network conforming to any standard, such as Controller Area Network (CAN, registered trademark), Ethernet, or FLEXRAY (registered trademark). The network topology shown in FIG. 2 is merely an example. The connection relationships between devices may be changed as appropriate. The vehicle control device 30 may also be connected to the motion actuator 20 via the in-vehicle network 101. The vehicle control device 30 corresponds to the vehicle control device.

The environmental sensor 11 is a sensor that recognizes the surrounding environment of the host vehicle Hv. The environmental sensor 11 includes, for example, one or more of a camera unit, millimeter-wave radar, LiDAR (Light Detection and Ranging/Laser Imaging Detection and Ranging), and sonar. The detection range of the environmental sensor 11 is set to include the entire periphery of the host vehicle Hv. The environmental sensor 11 detects moving objects and stationary objects within the detection range of the host vehicle Hv. Since the environmental sensor 11 monitors the surroundings of the host vehicle Hv, it may also be referred to as a surrounding monitoring sensor.

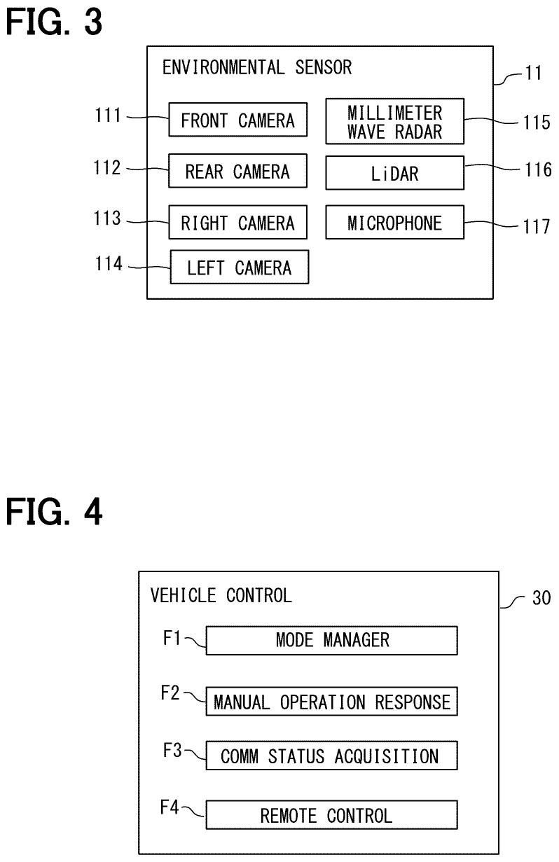

In the present embodiment, as shown in FIG. 3, the environmental sensor 11 includes a plurality of onboard cameras, namely, a front camera 111, a rear camera 112, a right camera 113, and a left camera 114. The front camera 111 is a camera that captures the front of the host vehicle Hv. The rear camera 112 is a camera that captures the rear of the host vehicle Hv. The right camera 113 and the left camera 114 are cameras that capture the sides of the host vehicle Hv, respectively. The environmental sensor 11 also includes one or more millimeter-wave radars 115. The one or more millimeter-wave radars 115 may include a front radar, which is a millimeter-wave radar that forms a detection range in front of the host vehicle Hv. Furthermore, the environmental sensor 11 may include one or more LIDARs 116. The environmental sensor 11 may also include one or more microphones 117 that capture external sounds. The microphone 117 may be incorporated into the onboard camera. The microphone 117 may also be referred to as an external microphone. Furthermore, the environmental sensor 11 may include an acoustic sensor that detects the external environment or a specific event (for example, the approach of an emergency vehicle) based on sound.

The environmental sensor 11, such as a camera, may be configured to detect and identify objects registered as detection targets from captured images using, for example, a discriminator applying deep learning. Detection targets may include moving objects such as pedestrians, cyclists, and other vehicles. Moving objects may also be referred to as road users (RU) or traffic participants. The environmental sensor 11 may also be configured to detect predetermined features (also referred to as a road feature, road object). Features to be detected by the environmental sensor 11 may include road surface markings, traffic signs, traffic signals, guardrails, road edges, and median strips. Road surface markings may include lane markings, pedestrian crossings, stop lines, or channelizing islands.

The environmental sensor 11 inputs data indicating detection results to the vehicle control device 30 via the in-vehicle network 101. Further, onboard cameras such as the front camera 111 provide captured image data to the wireless communication device 14 either through the vehicle control device 30 or directly, bypassing the vehicle control device 30. Note that the function of recognizing objects based on observation data generated by the environmental sensor 11 may be provided by another device connected to the sensor body, such as the vehicle control device 30. The observation data herein refers to image data generated by the camera, three-dimensional point cloud data generated by LiDAR, and reception result data of probe waves acquired by millimeter-wave radar/sonar, among others.

The vehicle state sensor 12 is a sensor that detects information relating to the state of the host vehicle Hv. The vehicle state sensor 12 includes a vehicle speed sensor, steering angle sensor, acceleration sensor, yaw rate sensor, and the like. The vehicle state sensor 12 may include a cabin sensor that generates information indicating whether occupants are present or the number of occupants.

The cabin sensor may include at least one of a DSM (Driver Status Monitor), seatbelt sensor, seating sensor, in-cabin camera, and in-cabin microphone. The in-cabin camera is a camera that captures images of the vehicle interior and may be an optical camera or an infrared camera. The in-cabin microphone is a microphone installed in the vehicle interior to collect interior sounds. The vehicle state sensor 12 outputs a signal indicating the detection result to the vehicle control device 30 via the in-vehicle network 101.

The locator 13 includes a GNSS (Global Navigation Satellite System) receiver, an inertial sensor, and other components. The locator 13 periodically calculates the position of the host vehicle Hv by combining positioning signals received from multiple positioning satellites by the GNSS receiver, measurement results from the inertial sensor, and vehicle speed information output to the communication bus. The position information of the host vehicle Hv may be represented by three-dimensional coordinates of latitude, longitude, and altitude. The locator 13 may also be configured to calculate the travel direction and moving speed of the host vehicle Hv using some or all of the above information. The locator 13 provides, as locator information, a data set including the position information of the host vehicle Hv based on calculation results to the vehicle control device 30.

The locator 13 may further include a map database (hereinafter, map DB) storing map data. The map DB mainly includes a large-capacity storage medium storing a large number of three-dimensional map data and two-dimensional map data. The three-dimensional map data is a so-called HD (High Definition) map and includes road information necessary for autonomous driving. The two-dimensional map data is navigation map data indicating the connection relationships of roads. The locator 13 may be configured to read out three-dimensional map data around the current position from the map DB and transmit it to the vehicle control device 30. The two-dimensional map data may be used for route search from the current position to the destination.

The map data stored locally in the host vehicle Hv may be updated by data received from a map server or the like via the wireless communication device 14. The map DB may be a storage device that temporarily holds map data received from the map server by the wireless communication device 14 until the data expires. The map DB may be provided separately from the locator 13.

The wireless communication device 14 is a device for enabling the onboard system 1 (primarily the vehicle control device 30) to perform wireless communication with an external device. The external device may include one or more of the remote monitoring system 5, other vehicles, servers, traffic information centers, roadside units, and mobile devices (for example, smartphones). The wireless communication device 14 is configured to be capable of cellular communication. Cellular communication refers to wireless communication conforming to LTE (Long Term Evolution), 4G, or 5G, among others. The wireless communication device 14 may also be configured to perform cellular V2X (PC5/Uu) or DSRC (Dedicated Short Range Communications).

The driving operation sensor 15 is a sensor that detects driving operations by the driver. The driving operation sensor 15 includes at least one of an accelerator sensor, brake sensor, and steering angle sensor. The accelerator sensor may be a sensor (so-called accelerator position sensor) that detects the depression amount (angle) of the accelerator pedal as the accelerator operation amount, or the accelerator input. The brake sensor may be a sensor (so-called brake pedal position sensor) that detects the depression amount (angle) of the brake pedal as the brake operation amount, or the brake input. The steering angle sensor is a sensor that detects the rotation angle (i.e., steering angle) of the steering wheel. The steering angle corresponds to the steering operation amount. The driving operation sensor 15 provides driver operation information including the accelerator operation amount, brake operation amount, and steering operation amount to the vehicle control device 30.

The operation amount may also be referred to as a driving instruction value or an operation command value. The driver operation information may be understood as information including a plurality of driving instruction values corresponding to accelerator operation, brake operation, and steering operation. The driver operation information may also include information relating to the operation of secondary actuators such as direction indicators and headlights. The driving operation sensor 15 may include switches or sensors for detecting driver operations of secondary actuators.

The speaker 16 is a device that outputs sound. The term “sound” in the present disclosure may include notification sounds, alarm sounds, buzzers, as well as voice and music. The speaker 16 outputs sound corresponding to an audio signal input from the vehicle control device 30 or the like.

The display device 17 is a display arranged in the vehicle interior. The display device 17 displays images corresponding to video signals input from the vehicle control device 30 or the like. When the host vehicle Hv is an owner car, the display device 17 may be arranged on the instrument panel or the like. In other embodiments, when the host vehicle Hv is a robot bus or robot taxi, the display device 17 may be arranged at any position visible to passengers.

The input device 18 is a device for receiving operations from occupants for in-vehicle devices such as the vehicle control device 30, air conditioning device, or audio device. The input device 18 may include a steering switch, switches arranged on the instrument panel, a touch panel, and the like. The input device 18 may include a switch for inputting a request to start or end remote control. Note that driving operation members such as the accelerator pedal, brake pedal, and steering wheel may also be regarded as a type of input device 18.

The external notification device 19 is a device for displaying information to persons present in the surroundings of the host vehicle Hv. Persons present in the surroundings of the host vehicle Hv include pedestrians, cyclists, kickboard users (or kick scooter users), and drivers of other vehicles. The external notification device 19 includes at least one of a brake lamp, direction indicator lamp, and hazard lamp. The external notification device 19 may include a display device (hereinafter also referred to as an outward-facing display) configured to present information toward the outside of the vehicle. The outward-facing display may be a liquid crystal display or organic EL display mounted on the exterior part of the vehicle or inside the window frame in a posture facing outside the vehicle. The outward-facing display may also be a projector that projects images onto the rear glass. The outward-facing display may also be an LED array. The external notification device 19 operates in accordance with instruction signals input from the vehicle control device 30. The external notification device 19 may be understood as a type of secondary actuator.

The motion actuator 20 is an actuator that generates power corresponding to acceleration, deceleration, or steering of the host vehicle Hv. The motion actuator 20 includes a powertrain including at least one of an engine and a drive motor. The motion actuator 20 relating to vehicle propulsion may also be referred to as a drive device. The drive device may be an engine, EV system, or hybrid system. The motion actuator 20 also includes a brake actuator and a steering actuator. The brake actuator may be a braking device. The brake actuator may include at least one of a hydraulic brake and a regenerative brake. The steering actuator may be an EPS (Electric Power Steering) motor.

The motion actuator 20 operates based on control signals input from the vehicle control device 30 and controls the movement of the host vehicle Hv. Other ECUs, such as a steering ECU for steering control, a power unit control ECU for controlling the drive source, and a brake ECU, may be interposed between the vehicle control device 30 and the motion actuator 20.

The vehicle control device 30 controls the movement of the host vehicle Hv by controlling the motion actuator 20 based on the detection results of the environmental sensor 11 and the driver operation information input from the driving operation sensor 15. The vehicle control device 30 may be implemented using one or more computers.

The vehicle control device 30 includes a processor 31, a memory 32, an input/output circuit 33, and a bus or the like connecting these components. The processor 31 may be a CPU or the like. The processor 31 corresponds to a processing unit or a control unit. The memory 32 includes a rewritable volatile storage medium coupled to the processor 31. The memory 32 may include, for example, RAM (Random Access Memory). The memory 32 may include a plurality of types of non-volatile storage media. The memory 32 may include, for example, a rewritable non-volatile memory such as flash memory as storage. The memory 32 stores a vehicle control program, which is a program executed by the processor 31. Execution of the vehicle control program by the processor 31 corresponds to execution of part or all of the vehicle control method.

The input/output circuit 33 is hardware for enabling the processor 31 to communicate with other devices (also referred to as difference devices) constituting the onboard system 1, such as the environmental sensor 11. The input/output circuit 33 may include circuits compatible with the communication methods of other devices. The input/output circuit 33 may be a communication interface or input/output port. The input/output circuit 33 corresponds to the communication unit or communication circuit. The input/output circuit 33 may support any type of wired or wireless communication. Part or all of the wireless communication device 14 may be included in the input/output circuit 33. Digital data corresponding to signals received by the input/output circuit 33 may be temporarily stored in the memory 32.

The input/output circuit 33 receives information from multiple devices connected to the vehicle control device 30. Reception may also be referred to as acquisition. The input/output circuit 33 acquires sensor data (i.e., detection results) from the environmental sensor 11. The sensor data includes data relating to objects present in the surroundings of the host vehicle Hv, such as other moving objects, features, and obstacles. Other moving objects are moving objects other than the host vehicle Hv. The data of detected objects may include the position, moving speed (relative speed), type, or size of the detected object. Sensor data relating to features may include data on lane markings and data on road edges.

In addition, the input/output circuit 33 acquires sensor data relating to the motion state of the host vehicle Hv, such as travel speed, acceleration, and yaw rate, from the vehicle state sensor 12. The input/output circuit 33 acquires data indicating the in-vehicle situation, such as the presence or absence of a driver and the driver's level of awareness, from cabin sensors such as DSM. Furthermore, the input/output circuit 33 acquires self-position data from the locator 13. The input/output circuit 33 may acquire map data of the area surrounding the host vehicle Hv by referring to the map DB.

The input/output circuit 33 may acquire data transmitted from external devices in cooperation with the wireless communication device 14. For example, the input/output circuit 33 may acquire data transmitted from the remote monitoring system 5. The input/output circuit 33 may also transmit data to the wireless communication device 14. The vehicle control device 30 may transmit and receive data with the remote monitoring system 5 using the wireless communication device 14.

The input/output circuit 33 acquires driver operation information from the driving operation sensor 15. The input/output circuit 33 also acquires information indicating the content of driver operations for the onboard system 1 based on signals from the input device 18. For example, the input/output circuit 33 may receive instructions relating to the start and end of remote control from the input device 18.

Various data sequentially acquired by the input/output circuit 33 are stored, for example, in the memory 32 or other temporary storage media and used by the processor 31 or the like. Data for which a certain period has elapsed since acquisition may be discarded. Various data (information) may be acquired by generation, conversion, determination, or calculation based on received signals from other devices. The input/output circuit 33 or processor 31 may have a function to generate other data based on raw data received from other devices. The processor 31 executes processing relating to travel control of the host vehicle Hv based on data received by the input/output circuit 33. The processor 31 corresponds to the processing unit.

### (Vehicle Control Device)

The vehicle control device 30 includes, as operation modes, a remote driving mode and a manual driving mode. The manual driving mode is an operation mode in which the movement of the host vehicle Hv is controlled in accordance with driver operations on the driving operation members. In the manual driving mode, the vehicle control device 30 controls the motion actuator 20 in accordance with the driver operation information input from the driving operation sensor 15. That is, the vehicle control device 30 determines the control amount for each of the brake actuator, powertrain, and steering actuator in accordance with the driver operation information, and outputs control signals corresponding to the determined control amounts to the motion actuator 20. Note that the manual driving mode may include a state in which driving assistance functions such as ACC described later are enabled.

The remote driving mode is an operation mode in which the movement of the host vehicle Hv is controlled in accordance with remote operation information received from the remote monitoring system 5 via the wireless communication device 14. The remote operation information, as will be described later, is information indicating the operation content of predetermined remote operation members by the operator 6. The remote operation information may also include a plurality of driving instruction values corresponding to accelerator operation amount, brake operation amount, and steering operation amount. In addition, the remote operation information may also include operation instructions for secondary actuators such as the external notification device 19.

Hereinafter, the remote driving mode may be simply referred to as RD (Remote Driving) mode. The RD mode may be understood as a state in which the remote control function of the vehicle control device 30 is enabled. In the RD mode, the vehicle control device 30 controls the motion actuator 20 in accordance with the remote operation information. That is, for each of the brake actuator, powertrain, and steering actuator, the vehicle control device 30 determines the control amount in accordance with the remote operation information, and outputs control signals corresponding to the determined control amounts to the motion actuator 20.

Such a vehicle control device 30 includes, as functional units realized by the processor 31 executing the vehicle control program, the functional units shown in FIG. 4. Specifically, the vehicle control device 30 includes a mode manager F1, a manual operation response unit F2, a communication state acquisition unit F3, and a remote control unit F4.

The mode manager F1 is a functional module that switches the operation mode of the vehicle control device 30. When the vehicle power supply is switched from off to on based on the pressing of the power switch, the initial operation mode of the vehicle control device 30 may be the manual driving mode. When the vehicle power supply is switched from off to on based on the reception of an activation command (i.e., remote operation) from the remote monitoring system 5, the initial operation mode of the vehicle control device 30 may be the RD mode.

When a specific remote control start condition is satisfied while the operation mode is the manual driving mode, the mode manager F1 switches the operation mode of the vehicle control device 30 from the manual driving mode to the RD mode. The switching to the RD mode may be executed based on transmitting a request for remote control to the remote monitoring system 5 in advance and receiving an affirmative response from the remote monitoring system 5.

The remote control start condition may be that the driver has exited the vehicle, the driver's awareness level has fallen below a predetermined level, a request to start remote control has been input by the driver or passenger, or a specific intervention command has been received from the remote monitoring system 5. The state in which the driver's awareness level is below a predetermined level may include a state in which the driver's consciousness is lost due to a sudden illness (so-called dead man state). The state in which the driver's awareness level is below a predetermined level may also include a state in which the driver's drowsiness level is above a predetermined value. The driver's awareness level or drowsiness level may be estimated based on biometric information detected by a DSM or similar device.

The mode manager F1 may periodically determine whether the remote control start condition has been satisfied while the manual driving mode is active. Events registered as remote control start conditions may also be referred to as remote start triggers.

Further, when a remote control end condition is satisfied while the operation mode is the RD mode, the mode manager F1 switches the operation mode from the RD mode to the manual driving mode. The switching to the manual driving mode may be executed based on outputting a request to start manual driving to the driver using the display device 17 or the speaker 16, and receiving an affirmative response from the driver. The affirmative response may be depression of the accelerator/brake pedal or gripping of the steering wheel.

The remote control end condition may be that an override operation by the driver has been detected, the driver has accepted a takeover request from the remote monitoring system 5, a specific location has been reached, or a communication failure state has continued for a predetermined period. The override operation is an input to the driving operation members provided in the host vehicle Hv. The override operation may be an accelerator operation, brake operation, or steering operation. The mode manager F1 may detect an override operation based on signals input from the driving operation sensor 15.

The mode manager F1 may periodically determine whether a remote control end condition has been satisfied while the RD mode is active. Events registered as remote control end conditions may also be referred to as remote end triggers. For safety, the vehicle control device 30 may be configured to perform switching between the manual driving mode and the RD mode, and vice versa, only while the vehicle is stopped.

The manual operation response unit F2 is a functional module that implements the manual driving mode. The manual operation response unit F2 is enabled when the manual driving mode is active and may be disabled during the RD mode. However, in order to promptly respond to an override operation by the driver, the manual operation response unit F2 may also remain enabled during the RD mode. During the RD mode, the manual operation response unit F2 may remain in a standby state.

The communication state acquisition unit F3 is a functional module that acquires the communication state between the wireless communication device 14 and the remote monitoring system 5. The communication state between the wireless communication device 14 and the remote monitoring system 5 may be understood as the communication state between the wireless communication device 14 and the remote control device 53, or the communication state between the vehicle control device 30 and the remote control device 53.

The communication state includes the round-trip delay time. The round-trip delay time is the time from when the wireless communication device 14 transmits data to the remote monitoring system 5 until a response is returned from the remote monitoring system 5. The round-trip delay time may also be referred to as RTT (Round Trip Time), round-trip latency, or communication delay time. The round-trip delay time may be measured by the vehicle control device 30 transmitting a specific message for connectivity confirmation, such as a Ping command, to the remote monitoring system 5. The measurement of the round-trip delay time may be performed periodically (for example, every 100 milliseconds).

In other embodiments, the communication state may include uplink communication speed and downlink communication speed. The communication state may include the communication method used for data communication (for example, 3G, LTE, 4G, 5G, 6G). Furthermore, the communication state may include indicators showing the communication state with the wireless base station providing the wireless section. The wireless base station may be, for example, an eNB (evolved Node B) or gNB (next generation NodeB). Indicators showing the communication state with the wireless base station may include RSRP, RSSI, or RSRQ. RSRP, RSSI, and RSRQ stand for Reference Signal Received Power, Received Signal Strength Indicator, and Reference Signal Received Quality, respectively. These indicators may be calculated, for example, by the wireless communication device 14 based on the reception results of reference signals (RS: Reference Signal) transmitted from the wireless base station.

Hereinafter, information indicating the communication state with the remote monitoring system 5 is also referred to as communication state information. As described above, the communication state information includes the round-trip delay time. The communication state information may also include at least one other indicator in addition to the round-trip delay time. The communication state information generated by the communication state acquisition unit F3 is stored in the memory 32 and referenced by the remote control unit F4. The communication state acquisition unit F3 may also directly provide the communication state information to the remote control unit F4.

The remote control unit F4 is configured to execute vehicle control based on the remote operation information. The vehicle control herein may include not only control of the motion actuator 20, but also control of secondary actuators, provision of information to the driver, and control of the air conditioning device.

The remote control unit F4 also executes processing incidental to remote control. For example, the remote control unit F4 may transmit data indicating the travel state of the vehicle as a travel state report to the remote monitoring system 5. The travel state report may include at least one of the following: vehicle position, travel speed, travel direction, yaw rate, remaining battery power, battery temperature, and the operating state of secondary actuators. The vehicle position may be position coordinates or an ego lane number. The ego lane number schematically indicates the position (so-called lateral position) of the host vehicle Hv in the road width direction. The ego lane number may be represented by the number of other lanes to the left (or right) of the host vehicle Hv.

The transmission of the travel state report may be periodically performed using the wireless communication device 14. For example, the remote control unit F4 may transmit a communication packet as a travel state report to the remote monitoring system 5 every 100 milliseconds or 200 milliseconds. The remote control unit F4 may execute periodic transmission of the travel state report at least while in the RD mode. Further, the remote control unit F4 may start periodic transmission of the travel state report from a predetermined time before the start of remote control. In other embodiments, the remote control unit F4 may also execute periodic transmission of the travel state report during the manual driving mode.

In addition, the remote control unit F4, at least while in the RD mode, periodically or continuously transmits external image data and external sound data to the remote monitoring system 5. The external images may include images from the front camera 111, rear camera 112, right camera 113, and left camera 114. The external sound data is sound data collected by the external microphone.

The remote control unit F4 may transmit images from each onboard camera to the remote monitoring system 5 using any real-time video streaming technology. The transmission of camera images may also include the transmission of sound data. The remote control unit F4 may start transmission of camera images from a predetermined time before the start of remote control. In other embodiments, the remote control unit F4 may continue to transmit camera images to the remote monitoring system 5 even while in the manual driving mode.

In other embodiments, when the host vehicle Hv is a service vehicle such as an unmanned operation bus, the remote control unit F4 may continue to transmit in-cabin image data to the remote monitoring system 5 in addition to external image data. The in-cabin images are images captured by the in-cabin camera. The in-cabin image data may include voice data of the driver/passengers collected by the in-cabin microphone.

### (Other Functions of the Vehicle Control Device)

The processor 31 recognizes the travel environment of the host vehicle Hv based on sensor data received by the input/output circuit 33. The sensor data may include at least one of map data, detection results of the environmental sensor 11, and data received by the wireless communication device 14. The processor 31 may recognize the travel environment of the host vehicle Hv by sensor fusion processing that integrates detection results from a plurality of environmental sensors 11.

The travel environment includes information relating to the structure (in other words, configuration) of the road within a predetermined distance ahead of the host vehicle Hv. The road structure may include the number of lanes, the position of the road edge, road width, and road curvature. The travel environment may include at least one of the ego lane number, weather, and road surface condition. The processor 31 may also acquire traffic regulations around the host vehicle Hv based on sensor data. The traffic regulations may include speed limits, lane change prohibitions, and the like.

The travel environment includes, for example, the position and type of objects present around the host vehicle Hv. The processor 31 may acquire the speed and travel direction of other detected moving objects. The processor 31 recognizes the position and behavior of other vehicles based on various data acquired using the input/output circuit 33. In this way, the travel environment includes at least the traffic situation in the travel direction (mainly forward) of the host vehicle Hv. That is, the processor 31 is configured to recognize the traffic situation in the travel direction of the host vehicle Hv using the environmental sensor 11 and the like.

The processor 31 may generate, as data indicating the travel environment, an environment model, which is a three-dimensional model reproducing (representing) the travel environment of the host vehicle Hv. The environment model may also be referred to as a world model. The environment model may be a model in which objects detected by the environmental sensor 11, such as moving objects like other vehicles, lane markers, road edges, and traffic signals, are arranged in a three-dimensional space based on the host vehicle Hv. The processor 31 may be understood as being configured to manage data relating to the travel environment. Data management herein may include acquisition (generation) and updating of data.

The vehicle control device 30 is equipped with an Advanced Emergency Braking (AEB) function. The AEB is control for avoiding collisions with other objects by braking. The processor 31 executes computation processing for AEB based on the above travel environment data. For AEB, the processor 31 calculates the time to collision (TTC) for each moving object detected in the travel direction of the host vehicle Hv. Specifically, the processor 31 determines the presence of a preceding vehicle and, if a preceding vehicle exists, calculates the TTC with respect to the preceding vehicle. The TTC may be simply calculated by dividing the inter-vehicle distance by the relative speed. The TTC may also be calculated using other algorithms that take into account relative acceleration and the like. Here, the preceding vehicle refers to the closest other vehicle to the host vehicle Hv traveling in the same lane ahead of the host vehicle Hv.

The processor 31 may calculate the TTC not only for preceding vehicles but also for other objects. If there is an obstacle in the travel direction of the host vehicle Hv, the processor 31 may also calculate the TTC for the obstacle. The processor 31 may calculate the TTC for pedestrians or cyclists crossing the road.

The processor 31 executes brake control as AEB when there is an object for which the TTC is less than a predetermined AEB activation threshold (Ta). In AEB, braking control is executed after an alert. The vehicle control device 30 may have two types of AEB activation thresholds registered: an alert threshold and a brake threshold. The alert threshold is the first AEB activation threshold for alerts. The brake threshold is the second AEB activation threshold for starting braking. The alert threshold may be set to a value greater than the brake threshold by a predetermined amount (for example, 0.8 seconds). Hereinafter, the AEB activation threshold refers to the brake threshold, but the AEB activation threshold described below may also be the alert threshold.

The processor 31 may execute AEB processing in the background regardless of the operation mode, that is, in either the manual driving mode or the RD mode. The AEB processing may include detection of objects, calculation of TTC, and comparison of TTC with the AEB activation threshold.

The processor 31 may also provide safety functions or driving assistance functions other than AEB. For example, the processor 31 may be configured to execute Advanced Emergency Steering (AES), Adaptive Cruise Control (ACC), and Lane Centering (LC).

The AES is control for avoiding collisions with objects by steering. The ACC is a driving assistance function that causes the host vehicle Hv to travel following a preceding vehicle while maintaining the lane. The LC is a driving assistance function that automatically controls steering so that the host vehicle Hv travels in the center of the lane. The LC may also be an Automated Lane Keeping System (ALKS).

In the manual driving mode, the processor 31 enables at least one of the ACC and LC functions in accordance with a support start request from the driver and executes processing according to the enabled driving assistance function. In the RD mode, the processor 31 enables at least one of the ACC and LC functions in accordance with a support start request from the operator and executes processing according to the enabled driving assistance function.

As driving assistance, the processor 31 may notify at least one of the driver and the operator of various information (hereinafter, support information). Notification of support information may be realized using at least one of image display, indicator lamp lighting, output of voice/notification sounds, and application of vibration. The support information may relate to at least one of objects with collision potential, the necessity of lane change, route at intersections, speed limits, traffic signal states, obstacles, lane baselines, and traffic congestion.

### (Remote Monitoring System)

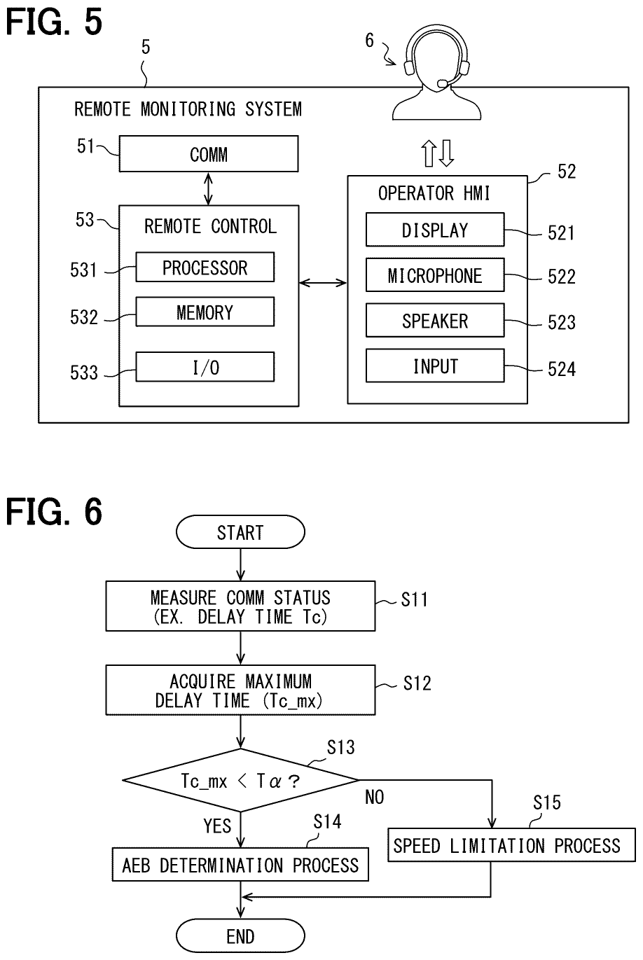

Here, the configuration of the remote monitoring system 5 will be described. As shown in FIG. 5, the remote monitoring system 5 includes a communication device 51, an operator HMI 52, and a remote control device 53. The term HMI in the component names is an abbreviation for Human Machine Interface. Note that the expression “host vehicle Hv” as a communication counterpart of the remote monitoring system 5 may be read as the onboard system 1 or the vehicle control device 30.

The communication device 51 is communication equipment for performing data communication with the host vehicle Hv (in other words, the onboard system 1) via a wide-area communication network. The communication device 51 may be connected to equipment constituting the wide-area communication network using, for example, optical fiber. The communication device 51 may also be configured to be capable of direct wireless communication with the wireless communication device 14. The communication device 51 receives data transmitted from the host vehicle Hv and outputs it to the remote control device 53. For example, the communication device 51 outputs travel state reports and camera images from the host vehicle Hv to the remote control device 53. In addition, the communication device 51 transmits data input from the remote control device 53 to the host vehicle Hv. For example, the communication device 51 transmits remote operation information and the like input from the remote control device 53 to the host vehicle Hv.

The operator HMI 52 is equipment that allows the operator 6 to check the travel state of the host vehicle Hv and remotely control the host vehicle Hv. The operator HMI 52 may also be used by the operator 6 to communicate with the driver/occupants. The operator HMI 52 includes a display device 521, a microphone 522, a speaker 523, and an input device 524.

The display device 521 displays images based on video signals input from the remote control device 53. For example, images from each camera of the host vehicle Hv may be displayed in separate screen windows on the display device 521. There may be one or more display devices 521. The display device 521 is arranged on the operator 6's desk. Various information such as support information, travel routes, and objects detected by the environmental sensor 11 may be displayed on the display device 521.

The microphone 522 is a microphone for the operator 6. The microphone 522 collects the voice spoken by the operator 6, converts it into an electrical signal, and outputs it to the remote control device 53. The speaker 523 converts audio signals input from the remote control device 53 into sound and outputs them. The speaker 523 and microphone 522 may be integrally configured as a headset for the operator 6.

The input device 524 is a device for receiving instruction operations from the operator 6 for the host vehicle Hv. As the input device 524, a keyboard, a dedicated device including multiple switches, or a touch panel laminated on the display device 521 may be used. The operator HMI 52 may include a talk switch as the input device 524. The talk switch corresponds to a switch for enabling the microphone 522 and outputting the operator 6's spoken voice from the speaker 16 of the host vehicle Hv.

In addition, the input device 524 includes driving operation members for the operator 6 to remotely operate the host vehicle Hv. That is, the input device 524 may include an accelerator pedal, brake pedal, steering wheel, shift lever, and light switch for the operator. The light switch may be a switch for switching the lighting state of at least one of the direction indicator, headlamp, front fog lamp (so-called fog lamp), and hazard lamp (so-called hazard warning lamp). The concept of a switch includes not only button-type switches but also lever-type, dial-type, and touch sensor-type switches. Note that some or all of the operator's driving operation members may be implemented using a touch panel, keyboard, or a controller for computer games/video games.

The remote control device 53 is mainly configured as a computer including a processor 531, a memory 532, and an input/output circuit 533. The processor 531 is hardware for computation processing coupled with the memory 532. The processor 531 includes at least one computation core such as a CPU. The processor 531 executes various processes by accessing the memory 532. The memory 532 includes volatile memory such as RAM. The memory 532 also includes non-volatile storage media such as flash memory.

The memory 532 stores a remote control program as a program executed by the processor 531. Execution of the above program by the processor 531 corresponds to execution of a remote control method corresponding to the remote control program. The remote control method may include part or all of the vehicle control method. Execution of the remote control program by the processor 531 may correspond to execution of part or all of the vehicle control method. The vehicle control method may be implemented by at least one of the processors 31 or 531.

The remote control device 53 is communicably connected to each of the communication device 51 and the operator HMI 52. Data signals from each of the communication device 51 and the operator HMI 52 are input to the remote control device 53. The remote control device 53 also outputs control signals and data signals to each of the communication device 51 and the operator HMI 52 as appropriate.

For example, the processor 531 displays external images, in-cabin images, and various status information of the host vehicle Hv received by the communication device 51 on the display device 521. Such processing corresponds to vehicle state notification processing that notifies the operator 6 of the internal or external situation of the host vehicle Hv. While the host vehicle Hv is in operation, the processor 531 may display images from each camera and various status information on the display device 521. The processor 531 may also display an image (for example, text or icon) indicating whether the host vehicle Hv is in the RD mode on the display device 521.

The processor 531 may also be configured to display external images and the like on the display device 521 in response to the satisfaction of the remote control start condition in the host vehicle Hv, or when the possibility thereof increases. The processor 531 may be configured to change the display content of the display device 521, such as the screen layout, according to whether the mode is the RD mode or manual driving mode. For example, during the manual driving mode, the processor 531 may mainly display a map image including the current position and planned travel route of the host vehicle Hv, and omit or display the camera images relatively small. On the other hand, during the RD mode, the processor 531 may display camera images, such as those from the front camera 111, relatively large.

The remote control device 53 receives driving operations for the host vehicle Hv from the operator 6 via the input device 524. That is, the remote control device 53 acquires accelerator operation amount, brake operation amount, shift position change, operation instructions for secondary actuators, and the like, based on input signals from the input device 524. The information relating to these operations constitutes the remote operation information. The remote control device 53 transmits the remote operation information to the host vehicle Hv using the communication device 51.

### (Operation of the Vehicle Control Device)

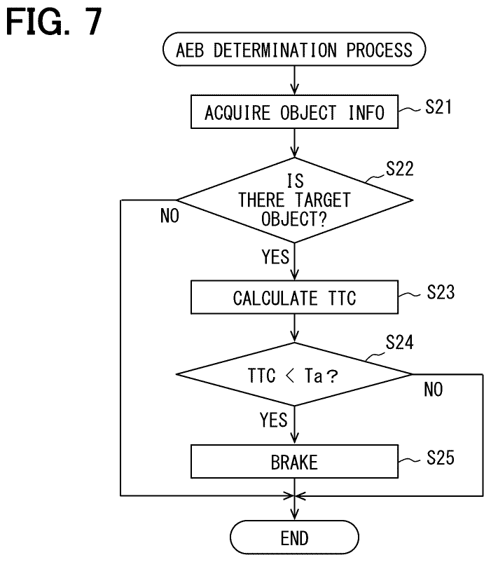

Here, an example of the operation of the vehicle control device 30 will be described with reference to the flowcharts shown in FIGS. 6 and 7. The series of processes shown in FIG. 6 is also referred to in this disclosure as communication delay response processing. The communication delay response processing may include lowering the upper speed limit for travel control in remote control when the communication delay time with the remote monitoring system 5 increases. The communication delay response processing may include, for example, S11 to S15, starting from S11.

S11 may be periodically executed while the operation mode is the RD mode. In other embodiments, S11 may also be periodically executed while the operation mode is manual driving mode. Further, if the host vehicle Hv is equipped with an autonomous driving mode as described later, the processor 31 may periodically execute S11 while the operation mode is autonomous driving mode. The description of the processor 31 as the executing entity of the following processes may be replaced with the vehicle control device 30 or the onboard system 1.

S11 is a step in which the processor 31 measures the communication state with the remote monitoring system 5 using the wireless communication device 14. As described above, the communication state here includes the round-trip delay time. The round-trip delay time may be measured by actually transmitting and receiving messages with the remote monitoring system 5. In the drawings, for simplification, the round-trip delay time is denoted as “Tc.” Hereinafter, the round-trip delay time may also be referred to as the communication delay time.

The processor 31 temporarily stores the acquired round-trip delay time together with a timestamp indicating the acquisition time in the memory 32. In S11, the processor 31 may also acquire other indicators indicating the communication state, such as RSRP or downlink communication speed, in addition to the round-trip delay time (Tc). After S11, S12 is executed.

In S12, based on a plurality of measured values of the round-trip delay time acquired within a predetermined period from the present to the past, the maximum delay time is identified. The maximum delay time is the maximum value (also referred to as the worst value) of the round-trip delay time within a predetermined period from the present to the past. The maximum delay time may be understood as the moving maximum value of the round-trip delay time within a predetermined period from the present to the past. The predetermined period here may be, for example, 1 second or 2 seconds. Alternatively, the predetermined period may be 5 seconds or 10 seconds.

The processor 31 may identify the maximum delay time from the history of round-trip delay times stored in the memory 32. Alternatively, the processor 31 may be configured to update the value of the maximum delay time by comparing the maximum delay time identified in the previous flow with the newly acquired round-trip delay time in S11. The measured value of the maximum delay time may have a validity period set. “Tc_mx” shown in FIG. 6 and the like represents the maximum delay time.

When the processor 31 identifies the maximum delay time, S13 is executed. S13 is a step in which the processor 31 compares the maximum delay time with a predetermined threshold (hereinafter, safety threshold: Ta). The safety threshold is a time parameter and is set, for example, to 0.6 seconds, 1.0 second, or 1.4 seconds. “Ta” in FIG. 6 and the like denotes the safety threshold.

In this embodiment, as an example, the safety threshold is set to a value greater than the AEB activation threshold by a predetermined amount (for example, 0.2 seconds). The safety threshold may be set based on the AEB activation threshold. In one embodiment, the safety threshold may be set to the same value as the AEB activation threshold. Therefore, the description of the safety threshold may be replaced with the AEB activation threshold.

If the maximum delay time is less than the safety threshold (S13 YES), the processor 31 executes the AEB determination processing in S14. On the other hand, if the maximum delay time is equal to or greater than the safety threshold (S13 NO), speed limiting processing is executed in S15.

The AEB determination processing in S14 is processing for determining whether to start brake control as AEB. As shown in FIG. 7, the AEB determination processing may include S21 to S25. S21 is a step of acquiring information on objects that may collide with the host vehicle Hv based on sensor data input from the environmental sensor 11. The object information acquired in S21 may be information on objects that may collide with the host vehicle Hv (hereinafter, also referred to as target objects).

The target object is an object in the travel direction of the host vehicle Hv. In many cases, the target object is a preceding vehicle. The target object may include obstacles such as parked vehicles, fallen objects, barricades for lane restrictions, and construction signs. Another road user whose trajectory intersects with that of the host vehicle Hv may also be included as target objects. The target object may be specified based on the predicted behavior of another road user and the planned trajectory of the host vehicle Hv.

When the host vehicle Hv is moving forward, the front of the host vehicle Hv is included in the travel direction. When the host vehicle Hv is turning right, the front and right directions of the host vehicle Hv are included in the travel direction. When the host vehicle Hv is turning left, the front and left directions of the host vehicle Hv are included in the travel direction. When the host vehicle Hv is reversing, the rear of the host vehicle Hv is included in the travel direction. The forward direction may include the diagonal forward direction, and the rear direction may include the diagonal rear direction.

S22 is a step of determining, as a result of S21, whether a target object exists. If no target object, i.e., no object with a possibility of contact with the host vehicle Hv, is detected (S22 NO), the AEB determination processing ends. On the other hand, if at least one target object is detected (S22 YES), the processor 31 executes S23 and S24 for each target object.

S23 is a step in which the processor 31 calculates the TTC for the target object. The method for calculating TTC is as described above. In S24, it is determined whether the calculated TTC is less than the AEB activation threshold (Ta). “Ta” in the figure represents the AEB activation threshold. If the TTC is less than the AEB activation threshold, the processor 31 executes brake control as AEB (also referred to as emergency braking). For example, the processor 31 outputs an execution command for brake control as AEB to a predetermined ECU or brake actuator.

It should be noted that S23 to S24, from another perspective, correspond to the step of determining whether there is any object for which the TTC is less than the AEB activation threshold. When there is an object for which the TTC is less than the AEB activation threshold, the processor 31 determines to execute AEB and inputs a control signal to the brake actuator to generate a predetermined braking force.

The speed limiting processing in S15 of FIG. 6 is processing for limiting the upper speed limit that can be input by the operator 6 in the RD mode. If the maximum delay time (Tc_mx) is greater than the safety threshold (or AEB activation threshold), there is an increased probability that a deceleration instruction via remote control will not be received in time, resulting in the AEB being activated by the judgment of the vehicle control device 30. Frequent activation of AEB may lead to reduced ride comfort for occupants or anxiety of another road user. The speed limiting processing in S15 is a function introduced (in other words, created) with attention to the above issues. In the vehicle control device 30 of the present embodiment, by lowering the upper speed limit for travel when the maximum delay time is equal to or greater than a predetermined value determined based on the AEB activation threshold, a reduction in travel speed is induced and the probability of AEB activation is reduced. The upper speed limit for travel (before reduction, in the absence of communication delay) may be the speed limit set for the road or a pre-registered value.

The speed limiting processing may be, for example, processing for determining the upper speed limit so that the TTC with respect to a reference vehicle becomes greater than the maximum delay time (Tc_mx). Here, the reference vehicle is basically the preceding vehicle. If there is another vehicle (hereinafter, an interrupting vehicle) that may cut in between the host vehicle Hv and the preceding vehicle, the reference vehicle may be the interrupting vehicle. The vehicle with the smaller TTC among the interrupting vehicle and the preceding vehicle may be used as the reference vehicle.

Specifically, if the distance to the reference vehicle is D, the travel speed of the reference vehicle is Vp, and the travel speed of the host vehicle Hv is Vh, the TTC with respect to the reference vehicle is defined by the following equation (1). Here, ΔV is the approach speed of the host vehicle Hv to the reference vehicle and is given by Vh-Vp.

$$( Equation 1 )$$

$$TTC = D / Δ V = D / ( Vh - Vp ) \qquad ( 1 )$$

The condition for Vh such that this TTC becomes greater than Tc_mx is obtained by substituting equation (1) into the left side of TTC>Tc_mx and solving for Vh. That is, Vh for which TTC becomes greater than Tc_mx may be expressed by the following equation (2).

$$( Equation 2 )$$

$$Vh < Vp + D / Tc\_mx \qquad ( 2 )$$

When there is another vehicle to be used as the reference vehicle, the processor 31 sets the value determined by the right side of the above equation (2) as the upper speed limit in the RD mode. The upper speed limit in the RD mode is the upper speed limit for travel that the vehicle control device 30 can realize (in other words, permit) in the RD mode. If, in the RD mode, the current travel speed has reached the upper speed limit, the processor 31 may be configured to invalidate any further acceleration instruction input as remote operation information and maintain the upper speed limit. Further, the processor 31 may be configured to decelerate at a predetermined deceleration rate to the upper speed limit if the current travel speed exceeds the upper speed limit in the RD mode.

In addition to the upper speed limit (hereinafter, TTC-based upper speed limit) obtained by the above equation (2), the processor 31 may be configured to acquire a basic value (hereinafter, basic upper speed) of the upper speed limit in the RD mode determined according to the travel environment. The basic upper speed may be set based on the speed limit set for the road. The basic upper speed may be the same as the speed limit or may be set to a value greater or less than the speed limit by a predetermined amount (for example, 10 km/h). The basic upper speed may be dynamically determined based on the speed limit of the road on which the host vehicle Hv is traveling.

The processor 31 may identify the speed limit by recognizing traffic signs using the front camera 111. The processor 31 may also acquire the speed limit based on map data. Furthermore, the processor 31 may identify the speed limit set for the road based on traffic information wirelessly distributed from roadside units. In other embodiments, the basic upper speed limit may be a fixed value (for example, 60 km/h).

The processor 31 may be configured to follow the smaller of the basic upper speed limit and the TTC-based upper speed limit. If there is no other vehicle corresponding to the reference vehicle, the processor 31 may control the travel speed in the RD mode according to the basic upper speed. In this manner, the processor 31 may be configured to determine the upper speed limit in the RD mode based on the traffic situation in the travel direction (for example, forward) of the host vehicle Hv and the communication state with the remote monitoring system 5.

Note that the upper speed limit in the RD mode may be determined based on parameters other than the TTC of the reference vehicle. In other embodiments, the processor 31 may be configured to use, as the upper speed limit in the RD mode, a value smaller by a predetermined amount (for example, 10 km/h) than the basic upper speed when the delay time is equal to or greater than a predetermined value. That is, the speed limiting processing may be processing for setting the upper speed limit in the RD mode to a value smaller by a predetermined amount (for example, 10 km/h) than the basic upper speed determined by the speed limit.

Further, in still other embodiments, the speed limiting processing may be processing for setting the upper speed limit in the RD mode to a value equal to or smaller by a predetermined amount than the travel speed of the reference vehicle. The processor 31 may be configured to set the upper speed limit in the RD mode to a value equal to or smaller by a predetermined amount than the travel speed of the reference vehicle. Thus, the processor 31 may be configured to determine the upper speed limit in the RD mode based on the moving speed of the reference vehicle when the communication delay time is equal to or greater than a predetermined value.

According to the above configuration, when the communication delay time between the host vehicle Hv and the remote monitoring system 5 exceeds a certain threshold, the upper speed limit for travel in remote control can be reduced. Therefore, the risk that the TTC with a preceding vehicle or the like becomes less than the AEB activation threshold can be reduced. In particular, according to a configuration in which the first speed limit is determined based on the speed of the reference vehicle or a value considering both the speed of the reference vehicle and the maximum delay time, the risk of AEB activation during remote control can be further reduced.

In addition, an upper limit is set for the travel speed during remote control. Therefore, even if the host vehicle Hv is illegally remotely operated by a third party, the risk of the host vehicle Hv traveling at an excessively high speed can be reduced.

Note that, in the above, an embodiment has been described in which the speed limiting processing is executed based on the communication delay time becoming equal to or greater than a predetermined value, but this is not limiting. The processor 31 may be configured to execute the speed limiting processing during the RD mode when another communication state parameter becomes less than or greater than a predetermined value. For example, the processor 31 may be configured to execute the speed limiting processing when the uplink communication speed, RSRP, RSSI, or RSRQ becomes less than a predetermined value. The processor 31 may be configured to adjust the upper speed limit in the RD mode according to the communication state between the wireless communication device 14 and the remote control device 53.

Note that the function of determining the upper speed limit in the RD mode in consideration of the communication state may be provided in the remote control device 53. The remote control device 53 may measure the communication state (such as the maximum delay time) with the vehicle control device 30 and determine the upper speed limit in the RD mode based on the measurement result. The remote control device 53 may restrict the operator 6's operations according to the determined upper speed limit. For example, if an acceleration instruction exceeding the upper speed limit is input, the remote control device 53 may reject the instruction. In that case, the remote control device 53 may display an image on the display device 521 indicating that the acceleration instruction is being rejected due to poor communication state.

### (Redundancy of AEB Function)

The remote control device 53 may also be configured to execute AEB determination processing while remotely controlling the host vehicle Hv. That is, the AEB function may be provided not only in the vehicle control device 30 but also in the remote control device 53. The AEB activation threshold used by the remote control device 53 may be set to a value different from that used by the vehicle control device 30 in consideration of communication delay.

For convenience, hereinafter, the AEB activation threshold used by the vehicle control device 30 may be referred to as the in-vehicle AEB threshold. The AEB activation threshold used by the remote control device 53 is referred to as the remote AEB threshold. The remote AEB threshold may be the same value as the in-vehicle AEB threshold. The in-vehicle AEB threshold is stored in the memory 32, and the initial value of the remote AEB threshold is stored in the memory 532.

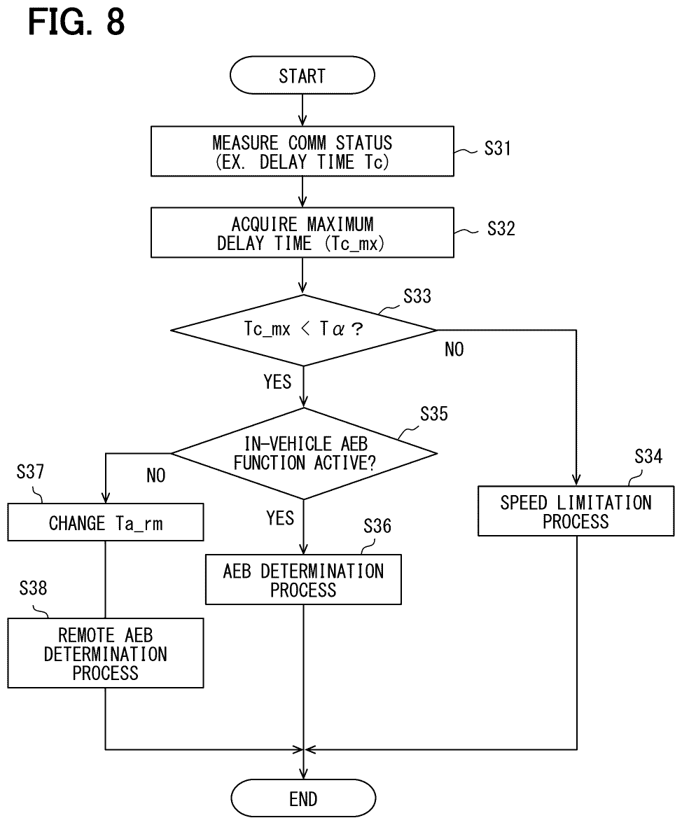

As described above, when the remote control device 53 is equipped with the AEB function, the remote control device 53 may be configured to dynamically change the remote AEB threshold according to the maximum delay time. FIG. 8 shows an example of the operation of such a vehicle management system Sys, which includes S31 to S38.

S31 to S33 and S34 are the same as S11 to S13 and S15 described above, and thus explanations thereof are omitted. If the maximum delay time (Tc_mx) is less than the safety threshold in S33, the remote control device 53 or the vehicle control device 30 determines whether the in-vehicle AEB function is enabled. The in-vehicle AEB function is the AEB function in the host vehicle Hv, and in substance, may be the AEB function provided by the vehicle control device 30.

The case where the in-vehicle AEB function is not enabled may be a case where there is a malfunction in the AEB program in the vehicle control device 30. Program malfunctions may include cases where the program has been tampered with, the program is outdated, or there are corrections in the updated program. The case where the in-vehicle AEB function is not enabled may also include cases where there is a malfunction in the hardware related to AEB in the vehicle control device 30. Hardware malfunctions related to AEB may include communication failures (e.g., disconnection) or memory sticking. Whether the in-vehicle AEB function is enabled may be determined by executing a predetermined inspection sequence. The inspection sequence is processing for confirming the operation of the program, etc. The case where the in-vehicle AEB function is not enabled may also include a pattern in which the onboard system 1 does not have the AEB function installed in the first place. If the host vehicle Hv is a vehicle type without the AEB function, S33 may always result in a negative determination.

If it is determined that the in-vehicle AEB function is enabled (S35 YES), the processor 31 executes S36. S36 may be the same processing as S14 described above. On the other hand, if it is determined that the in-vehicle AEB function is not enabled (S35 NO), the remote control device 53 changes the setting value of the remote AEB threshold (Ta_rm) in S37. “Ta_rm” in the figure denotes the remote AEB threshold. Note that the description of the remote control device 53 as the executing entity of the step may be appropriately replaced with the processor 531.

For example, if the initial value of the remote AEB threshold is Ta_i, in S37 the remote control device 53 sets the remote AEB threshold (Ta_rm) to the value obtained by adding the maximum delay time (Tc_mx) to the initial value (Ta_i). Specifically, if the initial value of the remote AEB threshold is 0.7 seconds and the maximum delay time is 0.4 seconds, the remote control device 53 sets the remote AEB threshold to 1.1 seconds. The remote control device 53 may acquire the maximum delay time via wireless communication with the vehicle control device 30 and execute S37.

Then, the remote control device 53 uses the remote AEB threshold determined in S37 to execute remote AEB determination processing in S38. The remote AEB determination processing may be processing in which the AEB activation threshold (Ta) used in the determination processing of S24 in FIG. 7 is replaced with the remote AEB threshold (Ta_rm). The remote control device 53 may calculate the TTC for each target object based on sensor data received from the host vehicle Hv and perform comparison with the remote AEB threshold.

If the calculated TTC is less than the remote AEB threshold, the remote control device 53 may transmit an AEB execution command to the host vehicle Hv via wireless communication. The AEB execution command is a signal instructing the execution of emergency braking. When the vehicle control device 30 receives the AEB execution command from the remote monitoring system 5 via the wireless communication device 14, it may promptly execute brake control as AEB.

According to the above configuration, the remote control device 53 can determine the necessity of AEB at an earlier timing in consideration of the communication delay time. As a result, the risk that the brake instruction by AEB is not received in time due to communication delay and the host vehicle Hv comes into contact with another object can be reduced.

Note that the remote control device 53 may execute S37 and S38 periodically, not only when it is determined that the in-vehicle AEB function is not enabled. That is, even when the in-vehicle AEB function is enabled, S37 and S38 may be executed so as to determine the necessity of AEB at a timing that takes the delay time into account. Further, the remote control device 53 may be configured to identify the communication state (for example, maximum delay time, etc.) between the remote monitoring system 5 and the host vehicle Hv, either together with or in place of the vehicle control device 30. The remote control device 53 may execute S37 and S38 based on the maximum delay time determined independently.

### (Introduction of Transmission Data Reduction Control)

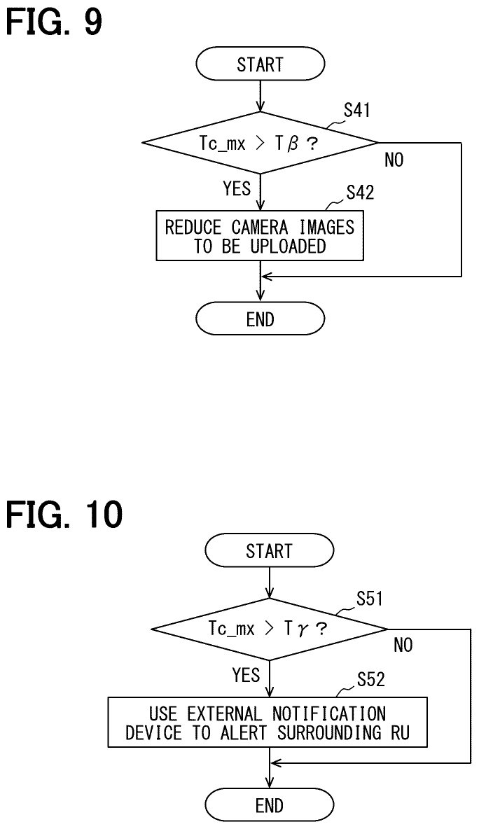

As shown in FIG. 9, when the maximum delay time (Tc_mx) is equal to or greater than a predetermined restriction threshold (TB) (S41 YES), the processor 31 may be configured to reduce the number of camera images transmitted to the remote monitoring system 5 (S42). “TB” in the figure represents the restriction threshold.

For example, when the maximum delay time is less than the restriction threshold, the processor 31 transmits all camera images to the remote monitoring system 5. On the other hand, when the maximum delay time is equal to or greater than the restriction threshold, the processor 31 transmits only camera images related to the travel direction to the remote monitoring system 5. The camera image related to the travel direction may be, for example, the image from the front camera 111. In another example, when the maximum delay time is less than the restriction threshold, the processor 31 transmits both the front camera image and the in-cabin camera image to the remote monitoring system 5, whereas when the maximum delay time is equal to or greater than the restriction threshold, only the image from the front camera 111 is transmitted to the remote monitoring system 5. By excluding the in-cabin camera image from upload when the maximum delay time is equal to or greater than the restriction threshold, congestion can be alleviated and the transmission delay of the front camera image can be expected to be reduced.

In this way, by changing the combination of camera images to be uploaded according to the communication state, it is possible to reduce the transmission delay of camera images with high importance or priority. In addition to, or instead of, changing the combination of camera images to be transmitted, the processor 31 may be configured to transmit images with reduced image quality. The reduction in image quality may be a reduction in frame rate, resolution, or both. In addition, the processor 31 may reduce the items transmitted in the travel state report when the maximum delay time is equal to or greater than the restriction threshold. As described above, the setting change for reducing the amount of data transmitted to the remote monitoring system 5 is also referred to as transmission data reduction control. When the transmission data reduction control is executed in the event of deteriorated communication state, the amount of data transmitted per unit time can be further reduced.

Note that by limiting the data transmitted by the vehicle control device 30 to the remote monitoring system 5, the information presented to the operator 6 is also limited. The control of this modification example may be understood as control for narrowing down the information presented to the operator 6 in response to the deterioration of the communication state between the vehicle control device 30 and the remote monitoring system 5.

The processor 31 may also be configured to execute transmission data reduction control during the RD mode when another communication state parameter becomes less than or greater than a predetermined value. For example, the processor 31 may be configured to execute transmission data reduction control when the uplink communication speed, RSRP, RSSI, or RSRQ becomes less than a predetermined value. The processor 31 may determine whether the communication state with the remote monitoring system 5 satisfies a specific condition. Here, the specific condition corresponds to a condition in which the communication state has deteriorated, in other words, the communication quality has deviated from a predetermined allowable range. The specific condition may be, for example, that the delay time has become equal to or greater than a predetermined value, or that the uplink communication speed, RSRP, RSSI, or RSRQ has become less than a predetermined value. The processor 31 may be configured to execute transmission data reduction control upon determining that the communication state with the remote monitoring system 5 satisfies the specific condition.

### (Control of External Notification Device)

As shown in FIG. 10, when the maximum delay time (Tc_mx) is equal to or greater than a predetermined external notification threshold (Tγ) (S51 YES), the processor 31 may be configured to execute alert control using the external notification device 19 (S52). “Tγ” in the figure represents the external notification threshold.

The alert control is control for prompting attention to the behavior of the host vehicle Hv to road users present around the host vehicle Hv (also referred to as a surrounding road user, or a surrounding RU). The alert control may include at least one of: (i) causing multiple types of lighting devices to blink in a predetermined pattern; (ii) displaying alert information on an outward-facing display device; and (iii) outputting a voice message to the outside indicating that a communication failure has occurred. In (i), for example, the brake lamp may be turned on and off in a predetermined pattern together with the hazard lamp. The alert information may be text or an image prompting surrounding road users to pay attention to the host vehicle Hv. More specifically, the alert information may be text or an image indicating that a communication failure has occurred in the host vehicle Hv.

According to a configuration in which the processor 31 executes the above-described alert control in response to deterioration in the communication state with the remote monitoring system 5, a surrounding road user may take measures such as keeping a distance from the host vehicle Hv. As a result, the safety of the occupants of the host vehicle Hv or another road user can be improved.

The processor 31 may also be configured to execute alert control during the RD mode when a communication state parameter other than the delay time becomes less than or greater than a predetermined value. For example, the processor 31 may be configured to execute alert control when the uplink communication speed, downlink communication speed, RSRP, RSSI, or RSRQ becomes less than a predetermined value. The processor 31 may determine whether the communication state with the remote monitoring system 5 satisfies a specific condition. Here, the specific condition may be that the delay time has become equal to or greater than a predetermined value, or that the uplink communication speed, downlink communication speed, RSRP, RSSI, or RSRQ has become less than a predetermined value. The processor 31 may be configured to execute alert control upon determining that the communication state with the remote monitoring system 5 satisfies the specific condition.

### (Route Setting in the Remote Control Device)

During remote control, the remote control device 53/operator 6 causes the host vehicle Hv to travel toward the destination. At that time, the remote control device 53 may determine the travel route of the host vehicle Hv in consideration of the communication quality for each road section. For example, as the route from the remote control start point of the host vehicle Hv to the destination, the remote control device 53 may select a route in which the total value of the delay time at each location is minimized, or a route in which there are no sections (or as few as possible) where the delay time is equal to or greater than a predetermined value, based on a radio wave map generated in advance.

The radio wave map is data indicating the estimated value of communication quality, in other words, the communication state for each location/road section. The radio wave map may be generated and updated based on the communication history for each location with the host vehicle Hv in the past. For generating the radio wave map, the remote control device 53 may be configured to periodically perform communication with the host vehicle Hv for measuring the communication state and store the position information of the host vehicle Hv and the measurement results in association in the memory 532. Further, for generating the radio wave map, the remote control device 53 may be configured to periodically perform wireless communication with the vehicle control device 30 in the background even while the host vehicle Hv is being manually driven.

In addition, when there are multiple vehicles (remote vehicles) managed by the remote monitoring system 5, a radio wave map indicating the communication quality for each location/road section may be generated from the communication history with the multiple remote vehicles. According to the above configuration, the remote control device 53 can guide the host vehicle Hv to a road section suitable for remote control based on the communication results with other remote vehicles. Further, by using the radio wave map, the remote control device 53 can acquire in advance the communication quality on the planned route to be traveled by the host vehicle Hv. As a result, before the communication quality actually deteriorates, the remote control device 53 can instruct the vehicle control device 30 to implement measures such as speed reduction, alert control, or transmission data reduction control.

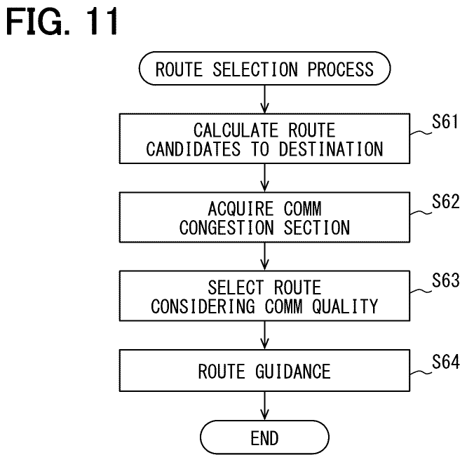

FIG. 11 is a flowchart showing an example of the operation of the remote control device 53 corresponding to the above technical concept, and includes S61, S62, and S63. S61 is a step of calculating one or more route candidates from the remote control start point to the destination based on map data indicating the connection relationships of roads. The remote control start point is the point at which remote control of the host vehicle Hv is started. In practice, the remote control start point may be the position coordinates of the host vehicle Hv at the time when the remote control start condition is satisfied. The destination may be a point preset by the driver or a point set by the operator 6. The destination may be the driver's home, a nearby parking lot, or the like. If the host vehicle Hv is a service vehicle, the destination may be a business office, terminal, or station registered as a home base. The destination may also be the next bus stop or the like. The destination may be changed dynamically.

When the calculation of route candidates is completed, the remote control device 53, in S62, extracts a communication congestion section included in the route candidates based on the radio wave map. The communication congestion section may be a section where the communication delay time is equal to or greater than a predetermined value, or a section where the uplink communication speed or the like is less than a predetermined value.

In S63, the remote control device 53 determines the final travel route in consideration of communication quality from among the route candidates. For example, the remote control device 53 may set, as the travel route, the route candidate with the smallest worst-case delay time among the plurality of route candidates. If there is only one route candidate, that route candidate may be set as the travel route.

Note that S61 to S63 may be integrated. The remote control device 53 may set the cost for each link according to the degree of communication congestion for each road section and determine the travel route using a predetermined route search method (for example, Dijkstra's algorithm). Here, a link refers to a road section in the map data.

Once the travel route is determined, the remote control device 53 supports the operator 6 in remotely operating the host vehicle Hv to travel along the travel route. Further, the vehicle control device 30 may activate driving assistance functions (such as automatic lane change) in the host vehicle Hv so that the host vehicle Hv travels along the travel route.

According to the above configuration, the host vehicle Hv preferentially travels on road sections where communication delay and the like are less likely to occur. Therefore, the problem of communication delay in remote control can be mitigated.

### (Supplement to Vehicle Control Device)

The vehicle control device 30 may, in one aspect, be implemented in the form of an automated driving system (ADS) or an automatic operation device. The vehicle control device 30 may be provided with an autonomous driving mode in addition to the manual driving mode and the RD mode as operation modes. The autonomous driving mode may hereinafter be simply referred to as the AD mode. AD means automated/autonomous driving.

The mode manager F1 switches the operation mode of the vehicle control device 30 based on at least one of the recognition result of the travel environment, the driver's operation, the operator 6's operation, or the judgment of the remote control device. That is, the mode manager F1 executes switching from the manual driving mode or the RD mode to the AD mode, and switching from the AD mode to the manual driving mode or the RD mode, based on any of the above inputs.

While in the AD mode, the vehicle control device 30 automatically performs dynamic driving tasks so that the host vehicle Hv travels along the planned travel route toward the destination. In other words, while in the AD mode, the vehicle control device 30 performs control for autonomous travel of the vehicle, such as recognition of the travel environment, planning of the travel trajectory, and motion control. The motion control includes speed adjustment by acceleration and deceleration, and steering control.

In the AD mode, the vehicle control device 30 may create a control plan for the host vehicle Hv using the detection results of the environmental sensor 11 and the map data stored in the map DB. The control plan may include information such as the schedule for acceleration and deceleration, the control schedule for steering angles, information on locations where lane changes are to be performed, and timings for notifying occupants in advance of lane changes or stops. Note that a part of the processing related to the creation of the control plan may be provided by the remote monitoring system 5.

In the AD mode, the vehicle control device 30 determines the control amount for each actuator based on the generated control plan and outputs control signals to each actuator. In addition, the vehicle control device 30 controls the turning on/off of direction indicators, headlights, hazard lamps, and the like, based on the created control plan and the external environment. The vehicle control device 30 may transmit data indicating the timing for lane changes, stops, starts, and right/left turns to the remote control device 53. The remote control device 53 may display the autonomous driving plan of the host vehicle Hv on the display device 521 and present it to the operator 6.

During the AD mode, the vehicle control device 30 may transmit a remote control start request to the remote control device 53 based on the satisfaction of specific conditions. For example, when the vehicle control device 30 detects or predicts an exit from the Operational Design Domain (ODD), it may transmit a remote control start request to the remote control device 53. In addition, when the vehicle control device 30 detects a malfunction in a system component related to the execution or maintenance of the autonomous driving function, it may transmit a remote control start request to the remote control device 53.

When the vehicle control device 30 detects a system abnormality or system limitation, it may first output a takeover request (TOR) to the driver, and if the driver does not respond, transmit a TOR to the operator 6. The TOR is a request, determined by the vehicle control device 30, for the driver or operator 6 to take over driving operations. The TOR may also be referred to as a takeover request, intervention request, or handover request.

As described above, the present disclosure may be applied to vehicles capable of autonomous driving. Note that the vehicle control device 30 does not need to be constituted by a single computer and may be divided among multiple computers (for example, ECUs: Electronic Control Units). The above-described vehicle control device 30 may be implemented using multiple ECUs. In such a case, the functional allocation among the multiple ECUs may be appropriately designed.

Furthermore, the vehicle control device 30 does not necessarily need to be provided with a manual driving mode. The vehicle control device 30 may be provided only with the AD mode and the RD mode, without a manual driving mode. That is, the host vehicle Hv may be an unmanned operation bus or the like. In addition, the host vehicle Hv and the vehicle control device 30 may be vehicles/devices dedicated to remote control, without manual driving mode or autonomous driving mode.

The present disclosure includes the following technical concepts. In addition, methods, programs, and storage media recording such programs corresponding to the following technical concepts are also included in the present disclosure.

### Technical Concept 1

A vehicle control device used in a vehicle configured to be remotely controllable comprises: a communication unit configured to communicate with one or more other devices mounted on the vehicle; and a processing unit configured to executes processing relating to travel control of the vehicle based on data received by the communication unit. The one or more other devices include a wireless communication device configured to be capable of wireless communication with a remote control device, which is an external device used to remotely control the vehicle. The processing unit is configured to: acquire a communication state between the remote control device and the wireless communication device based on data received from the wireless communication device by the communication unit; and dynamically adjust an upper speed limit, which is the upper limit of travel speed in remote control of the vehicle, according to the communication state.

### Technical Concept 2

In the vehicle control device according to Technical Concept 1, the communication unit is configured to be capable of communicating with a plurality of other devices,
the plurality of other devices include, in addition to the wireless communication device, an environmental sensor configured to output data indicating the traffic situation in the travel direction of the vehicle, and
the processing unit is configured to: acquire the traffic situation in the travel direction based on data received from the environmental sensor by the communication unit; and determine the upper speed limit in the remote control based on the communication state and the traffic situation in the travel direction.

### Technical Concept 3

In the vehicle control device according to Technical Concept 1, the communication unit is configured to be capable of communicating with a plurality of other devices,
the plurality of other devices include, in addition to the wireless communication device, an environmental sensor that outputs data indicating the moving speed of another moving object in the travel direction of the vehicle, and
the processing unit is configured to: acquire the moving speed of the another moving object in the travel direction based on data received from the environmental sensor by the communication unit; and determine the upper speed limit in the remote control based on the communication state and the moving speed of the another moving object.

### Technical Concept 4

In the vehicle control device according to Technical Concept 1, the communication unit is configured to be capable of communicating with a plurality of other devices,
the plurality of other devices include, in addition to the wireless communication device, an environmental sensor that outputs data indicating the relative speed of another moving object in the travel direction of the vehicle,
the communication state is a communication delay time, and
the processing unit is configured to: acquire the relative speed of the moving object in the travel direction based on data received from the environmental sensor by the communication unit; calculate a time to collision with the moving object based on the relative speed; and determine the upper speed limit such that the time to collision is greater than the communication delay time.

### Technical Concept 5

In the vehicle control device according to Technical Concept 1, the processing unit is configured to, when the communication delay time is equal to or greater than a predetermined value, adjust the upper speed limit such that the time to collision is greater than the communication delay time.

### Technical Concept 6

In the vehicle control device according to any one of Technical Concepts 1 to 5, the processing unit is configured to, while the remote control is enabled, periodically or continuously transmit data relating to the travel state of the vehicle to the remote control device using the wireless communication device, and
the processing unit is further configured to: determine whether the communication state satisfies a specific condition; and upon determining that the communication state satisfies the specific condition, execute control to reduce the data amount per unit time transmitted to the remote control device.

### Technical Concept 7

In the vehicle control device according to Technical Concept 6, the communication unit is configured to be capable of communicating with a plurality of other devices,
the plurality of other devices include, in addition to the wireless communication device, a plurality of onboard cameras, and
the processing unit is configured to: transmit images from two or more onboard cameras to the remote control device when the communication state satisfies the specific condition; and, when the communication state does not satisfy the specific condition, reduce the number of onboard cameras from which images are transmitted to the remote control device as compared to when the communication state satisfies the specific condition.

### Technical Concept 8

In the vehicle control device according to any one of Technical Concepts 1 to 7, the communication unit is configured to be capable of communicating with a plurality of other devices,
the plurality of other devices include, in addition to the wireless communication device, an external notification device, and
the processing unit is configured to: determine whether the communication state satisfies a specific condition; and upon determining that the communication state satisfies the specific condition, use the external notification device to prompt attention to another road user present in the surroundings of the vehicle.

### Technical Concept 9

In the vehicle control device according to Technical Concept 8, the external notification device includes a display device configured to present information outside the vehicle, and
the processing unit is configured to: determine whether the communication state satisfies a specific condition; and upon determining that the communication state satisfies the specific condition, present information for alerting or information for prompting attention using the display device.

Note that, in Technical Concept 6, adjustment of the upper speed limit in remote control is not an essential element, and the present disclosure may also include the following technical concept. According to the following technical concept, even when the communication state is not favorable, the upload speed of relatively important data can be more easily maintained. As a result, the situation monitoring function for the controlled vehicle in the remote control device is maintained, and safety in remote control can be improved.

### Technical Concept 10

A vehicle control device for use in a vehicle configured to be remotely controllable comprises: a communication unit configured to communicate with one or more other devices mounted on the vehicle; and a processing unit configured to execute processing relating to travel control of the vehicle based on data received by the communication unit. The one or more other devices include a wireless communication device configured to be capable of wireless communication with an external device used to remotely control the vehicle, namely a remote control device. The processing unit is configured to, while the remote control is enabled, periodically or continuously transmit data relating to the travel state of the vehicle to the remote control device using the wireless communication device. The processing unit is further configured to: acquire a communication state between the remote control device and the wireless communication device based on data input from the communication unit; determine whether the communication state satisfies a specific condition; and upon determining that the communication state satisfies the specific condition, execute control to reduce the data amount per unit time transmitted to the remote control device.

Further, in Technical Concept 8, adjustment of the upper speed limit in remote control is not an essential element, and the present disclosure may also include the following technical concept. According to the following technical concept, when the communication state is not favorable, surrounding road users are alerted using the external notification device. As a result, the safety of the remotely controlled vehicle or surrounding road users can be improved.

### Technical Concept 11

A vehicle control device for use in a vehicle configured to be remotely controllable comprises: a communication unit configured to communicate with a plurality of other devices mounted on the vehicle; and a processing unit configured to execute processing relating to travel control of the vehicle based on data received by the communication unit. The plurality of other devices include a wireless communication device (14) configured to be capable of wireless communication with an external device used to remotely control the vehicle, namely a remote control device, and an external notification device (19). The processing unit is configured to: acquire a communication state between the remote control device and the wireless communication device based on data input from the communication unit; determine whether the communication state satisfies a specific condition; and upon determining that the communication state satisfies the specific condition, use the external notification device to prompt attention to another road user present in the surroundings of the vehicle.

The various flowcharts shown in the present disclosure are merely examples, and the number of steps constituting the flowcharts and the execution order of the processes can be appropriately changed. The controls shown in each flowchart may be combined and/or executed in parallel to the extent that there is no contradiction. Expressions such as acquisition, determination, detection, generation, and calculation may be used interchangeably. The acquisition of certain data by a device may include the case where the device generates the data based on signals input from other devices or sensors.

The devices, systems, and methods described in the present disclosure may be implemented by a dedicated computer comprising a processor programmed to execute one or more functions embodied by a computer program. The devices and methods described in the present disclosure may be implemented using dedicated hardware logic circuits. The devices and methods described in the present disclosure may also be implemented by one or more dedicated computers comprising a combination of a processor that executes a computer program and one or more hardware logic circuits. The processor may be any arithmetic core, such as a CPU, MPU, GPU, or DFP (Data Flow Processor). Some or all of the functions provided by the vehicle management system may be implemented as hardware. Some or all of the functions provided by the vehicle control device or the remote control device may be implemented using a System-on-Chip (SoC), Integrated Circuit (IC), or Field-Programmable Gate Array (FPGA).

The computer program includes instructions executed by a computer. The computer program may be stored on a computer-readable non-transitory tangible storage medium. The recording medium for the computer program may be any of various media, such as an HDD (Hard-disk Drive), SSD (Solid State Drive), or flash memory.

What is claimed is:

1. A vehicle control device used in a vehicle configured to be remotely controllable, the vehicle control device comprising:
a communication unit configured to communicate with one or more other devices mounted on the vehicle, the one or more other devices including a wireless communication device configured to execute wireless communication with a remote control device, which is an external device used to remotely control the vehicle; and
at least one of (i) a circuit and (ii) a processor with a memory storing computer program code executable by the processor, the at least one of the circuit and the processor configured to function as a processing unit that executes processing relating to travel control of the vehicle based on data received by the communication unit,
wherein
the processing unit is configured to:
acquire a communication state between the remote control device and the wireless communication device based on data from the wireless communication device received by the communication unit; and
dynamically adjust an upper speed limit, which is an upper limit of travel speed in remote control of the vehicle, according to the communication state.

2. The vehicle control device according to claim 1, wherein
the one or more other devices is a plurality of other devices,
the communication unit is configured to communicate with the plurality of other devices,
the plurality of other devices include, in addition to the wireless communication device, an environmental sensor that outputs data indicating a traffic situation in a travel direction of the vehicle, and
the processing unit is configured to:
acquire the traffic situation in the travel direction based on data from the environmental sensor received by the communication unit; and
determine the upper speed limit in the remote control based on the communication state and the traffic situation in the travel direction.

3. The vehicle control device according to claim 1, wherein
the one or more other devices is a plurality of other devices,
the communication unit is configured to communicate with the plurality of other devices,
the plurality of other devices include, in addition to the wireless communication device, an environmental sensor that outputs data indicating a moving speed of another moving object in a travel direction of the vehicle, and
the processing unit is configured to:
acquire the moving speed of another moving object in the travel direction based on data from the environmental sensor received by the communication unit; and
determine the upper speed limit in the remote control based on the communication state and the moving speed of another moving object.

4. The vehicle control device according to claim 1, wherein
the one or more other devices is a plurality of other devices,
the communication unit is configured to communicate with the plurality of other devices,
the plurality of other devices include, in addition to the wireless communication device, an environmental sensor that outputs data indicating a relative speed of another moving object in a travel direction of the vehicle,
the communication state includes a communication delay time, and
the processing unit is configured to:
acquire the relative speed of another moving object in the travel direction based on data from the environmental sensor received by the communication unit;
calculate a time to collision with another moving object based on the relative speed; and
determine the upper speed limit such that the time to collision is greater than the communication delay time.

5. The vehicle control device according to claim 4, wherein
the processing unit is configured to, when the communication delay time is equal to or greater than a predetermined value, adjust the upper speed limit such that the time to collision is greater than the communication delay time.

6. The vehicle control device according to claim 1, wherein
the processing unit is configured to, while the remote control is active, periodically or continuously transmit data relating to a travel state of the vehicle to the remote control device with the wireless communication device,
the processing unit is configured to:
determine whether the communication state satisfies a specific condition; and
upon determining that the communication state satisfies the specific condition, reduce data amount per unit time transmitted to the remote control device.

7. The vehicle control device according to claim 6, wherein
the one or more other devices is a plurality of other devices,
the communication unit is configured to communicate with the plurality of other devices,
the plurality of other devices include, in addition to the wireless communication device, a plurality of onboard cameras, and
the processing unit is configured to:
transmit images of two or more onboard cameras to the remote control device when the communication state satisfies the specific condition; and
reduce the number of onboard cameras that transmit images to the remote control device, as compared to when the communication state satisfies the specific condition when the communication state does not satisfy the specific condition.

8. The vehicle control device according to claim 1, wherein
the one or more other devices is a plurality of other devices,
the communication unit is configured to communicate with the plurality of other devices,
the plurality of other devices include, in addition to the wireless communication device, an external notification device, and
the processing unit is configured to:
determine whether the communication state satisfies a specific condition; and
upon determining that the communication state satisfies the specific condition, use the external notification device to prompt attention to another road user present in surroundings of the vehicle.

9. The vehicle control device according to claim 8, wherein
the external notification device includes a display device configured to present information outside the vehicle, and
the processing unit is configured to:
determine whether the communication state satisfies the specific condition; and
upon determining that the communication state satisfies the specific condition, present information for prompting attention with the display device.

10. A remote control system comprising:
a vehicle control device used in a vehicle configured to be remotely controllable; and
an external system disposed outside the vehicle for remotely controlling the vehicle,
wherein
the vehicle control device includes:
a communication unit configured to communicate with a wireless communication device that execute wireless communication with the external system; and
a processing unit configured to execute processing relating to travel control of the vehicle based on data received by the communication unit,
the processing unit is configured to:
acquire a communication state between the external system and the wireless communication device based on data received from the wireless communication device by the communication unit; and
dynamically adjust an upper speed limit, which is an upper limit of travel speed in a remote control of the vehicle, according to the communication state,
the external system includes:
a communication device configured to communicate with the vehicle control device; and
a remote control device configured to execute processing for remotely controlling the vehicle based on data received by the communication device,
the remote control device is configured to:
acquire the communication state in association with position information of the vehicle with the communication device;
store data of the communication state for each location in a memory; and
determine a travel route of the vehicle based on the data of the communication state for each location stored in the memory.
